(19) United States
(12) Patent Application Publication
(10) Pub. No.: US 2008/0029038 A1
(43) Pub. Date: Feb. 7, 2008

(54) Litter box air evacuation method

(76) Inventor: Deborah June Chilcoat, Plano, TX (US)

Correspondence Address: JOHN BRUCKNER, P.C., P.O. BOX 490, FLAGSTAFF, AZ, 86002, US

(21) Appl. No.: 11/904,969

(22) Filed: Sep. 27, 2007

Related U.S. Application Data
(62) Division of application No. 11/169,965, filed on Jun. 29, 2005.
Application No. 11/169,965 is a continuation-in-part of application No. 11/069,658, filed on Mar. 1, 2005.

(51) Int. Cl. A01K 29/00

(52) U.S. Cl. 119/165

(57) ABSTRACT

Methods and apparatus are described for a litter box vacuum air filtration system. An apparatus includes a stack of pet furniture units including a litter box unit including a vacuum inlet, a fan coupled to the vacuum inlet; and a litter box air shaft coupled to the fan; and another box unit coupled to the litter box unit, the another box unit including another air shaft. The litter box air shaft and the another box air shaft are coupled together to align the litter box air shaft with the another air shaft and define a ventilation conduit: A method includes operating a litter box unit including evacuating gas from the litter box unit through a vacuum inlet that defines an air intake that is located along substantially all of an upper, interior edge of the litter box.

### CROSS-REFERENCE TO RELATED APPLICATION

This application is a division of, and claims a benefit of priority under 35 U.S.C. 120 from copending utility patent application U.S. Ser. No. U.S. Ser. No. 11/169,965, filed Jun. 29, 2005 which in-turn in continuation-in-part of Ser. No. 11/069,658, filed Mar. 1, 2005, the entire contents of which are hereby expressly incorporated herein by reference for all purposes.

### BACKGROUND INFORMATION

1. Field of the Invention

The invention relates generally to the field of pet furniture. More particularly, an embodiment of the invention relates to cat furniture comprised of a vertical series of sections.

2. Discussion of the Related Art

Litter boxes can be messy. Prior art litter box liners, sometimes called cat pan liners, to help control the mess are known. For instance, the interior of a cat box or pan can be provided with a liner that is in-turn filled with granular litter material. Cleaning such a liner equipped litter box involves lifting the liner, thereby removing the litter from the box or pan, and then replacing the liner and replenishing the litter.

A problem with this approach is that removal of soiled litter by lifting the liner necessarily involves removal of all the litter when lifting out the liner. Consequently, additional maintenance steps are required including providing a fresh liner and replenishing the litter.

Another approach, in an attempt to reduce the rate of litter consumption and avoid extra maintenance steps, without obviating the benefits of using a liner, is to use a sifting litter box liner. For example, a flat sheet of plastic can be provided with a section having perforations arranged in a two-dimensional array.

Referring to FIG. 1, it is known to provide a bag 16 with netting 40 as described in U.S. Pat. No. 5,983,832. After removing the protective insert 44, the litter 20 is sifted when the bag 16 is lifted up, thereby separating the waste 24 and leaving the litter 20 on top of the next bag.

Sifting liners are designed for use with clumping litter. The edges are gathered together and when lifted, they sift the litter.

However, a disadvantage of all known liners (sifting or not) is that they do not extend vertically any further up than the top of the sidewalls of the box or pan in which they are placed. These are usually 6 to 8 inches tall. When urinating some/most cats spray outward instead of downward. This results in urine above the liner. With most box designs, the urine will be forced through the top and bottom sections with or without a liner in use. The inevitable result with some (if not most) cats is that some of the animal's waste and/or some of the litter is thrown up and outside the liner, thereby requiring periodic cleaning of the surrounding area and/or the interior of an enclosure, if such an enclosure surrounds the box or pan. This can be a particularly troublesome problem when the liners are used in combination with an enclosure and the interior of the enclosure includes seam(s) and/or porous material(s) such as wood.

What is needed is a solution that extends the protection of a liner further up vertically than the sidewalls of a box or pan to protect a surrounding area and/or the interior of an enclosure that surrounds the box or pan. What is also needed is a solution that does not mitigate the lowered litter consumption rate and labor saving aspects of a sifting liner.

### SUMMARY OF THE INVENTION

There is a need for the following embodiments of the invention. Of course, the invention is not limited to these embodiments.

According to an embodiment of the invention, a manufacture comprises: a shaped sifting litter box liner including a sifting web having a section the defines a plurality of perforations adapted to sift clumping litter; and an entry web coupled to the sifting web, the entry web defining an entry structure adapted to permit passage of an animal through the entry web. According to another embodiment of the invention, a manufacture comprises: a litter box including a base web; and an entry web coupled to the sifting web via an entry web seam, the entry web defining an entry structure adapted to permit passage of an animal through the entry web, wherein the entry structure includes an aperture located in the entry web and the entry web includes a fastener located proximate the aperture, the fastener adapted to seal the aperture to a shaped sifting litter box liner. According to an embodiment of the invention, a process comprises: locating a shaped sifting litter box liner within an interior of a litter box, wherein the shaped sifting litter box liner includes a sifting web having a section that defines a plurality of perforations adapted to sift clumping litter and an entry web coupled to the sifting web, the entry web defining an entry structure adapted to permit passage of an animal through the entry web; and removably connecting the shaped sifting litter box liner to the interior of the litter box.

According to another embodiment of the invention, an apparatus, comprises: a stack of pet furniture units including a litter box unit including a vacuum inlet, a fan coupled to the vacuum inlet; and a litter box air shaft coupled to the fan; and another box unit coupled to the litter box unit, the another box unit including another air shaft, wherein the litter box air shaft and the another box air shaft are coupled together to align the litter box air shaft with the another air shaft and define a ventilation conduit. According to another embodiment of the invention, a method comprises assembling a stack of pet furniture units including aligning and coupling together a litter box air shaft and another box air shaft to define a ventilation conduit, wherein a litter box unit includes a vacuum inlet, a fan coupled to the vacuum inlet; and the litter box air shaft, the litter box air shaft coupled to the fan and wherein another box unit is coupled to the litter box unit, the another box unit including the another air shaft. According to another embodiment of the invention, a method, comprises: operating a stack of pet furniture units including evacuating gas from a litter box unit through a ventilation conduit defined by a litter box air shaft and another box air shaft that are aligned and coupled together; and imparting motion to a moving part by impinging the moving part with evacuated gas.

According to another embodiment of the invention, an apparatus comprises a litter box including a vacuum inlet, a fan coupled to the vacuum inlet; filter assembly coupled to the fan; and a vacuum outlet coupled to the filter assembly, wherein the vacuum inlet defines an air intake that is located along substantially all of an upper, interior edge of the litter box. According to another embodiment of the invention, a method comprises operating a litter box unit including evacuating gas from the litter box unit through a vacuum inlet, wherein the vacuum inlet defines an air intake that is located along substantially all of an upper, interior edge of the litter box.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of an embodiment of the invention without departing from the spirit thereof, and embodiments of the invention include all such substitutions, modifications, additions and/or rearrangements.

### BRIEF DESCRIPTION OF THE DRAWINGS

The drawings accompanying and forming part of this specification are included to depict certain embodiments of the invention. A clearer conception of embodiments of the invention, and of the components combinable with, and operation of systems provided with, embodiments of the invention, will become more readily apparent by referring to the exemplary, and therefore nonlimiting, embodiments illustrated in the drawings, wherein identical reference numerals (if they occur in more than one view) designate the same elements. Embodiments of the invention may be better understood by reference to one or more of these drawings in combination with the description presented herein. It should be noted that the features illustrated in the drawings are not necessarily drawn to scale.

FIG. 1 is a sectional view of a conventional litter box with a protective insert and a disposal bag, appropriately labeled “PRIOR ART.”

FIGS. 2A, 2B and 2C are perspective views of a litter box, a plurality of shaped sifting liners and a cover, respectively, that can be combined in an assembly, representing an embodiment of the invention.

FIGS. 3A, 3B and 3C are perspective views of another litter box, a plurality of shaped sifting liners and a cover, respectively, that can be combined in another assembly, representing an embodiment of the invention.

FIGS. 4A, 4B and 4C are perspective views of another litter box, a shaped sifting liner and a cover, respectively, that can be combined in another assembly, representing an embodiment of the invention.

FIG. 5 is a perspective view of a plurality of shaped sifting liners, each of which includes a snap fit structure located around a side aperture, representing an embodiment of the invention.

FIG. 6 is a perspective view of a plurality of shaped sifting liners, each of which includes a zip lock structure located around a side aperture, representing an embodiment of the invention.

FIG. 7 is a perspective view of a plurality of shaped sifting liners, each of which includes a draw string closure at the open top of the liner and another draw string closure around the side aperture, representing an embodiment of the invention.

FIGS. 8A and 8B are perspective views of a round shaped (FIG. 8A) vertical stack of pet furniture units and a square shaped (FIG. 8B) vertical stack of pet furniture units, representing embodiments of the invention.

FIG. 9 is an orthographic view of a front of a square shaped vertical stack of pet furniture units, representing an embodiment of the invention.

FIG. 10 is an orthographic view of a first (right) side of a square shaped vertical stack of pet furniture units, representing an embodiment of the invention.

FIG. 11 is an orthographic view of a back of a square shaped vertical stack of pet furniture units, representing an embodiment of the invention.

FIG. 12 is an orthographic view of a second (left) side of a square shaped vertical stack of pet furniture units, representing an embodiment of the invention.

FIG. 13 is a cross sectional (interior) view of a front of a square shaped vertical stack of pet furniture units, representing an embodiment of the invention.

FIG. 14 is a cross sectional (interior) view of a first (right) side of a square shaped vertical stack of pet furniture units, representing an embodiment of the invention.

FIG. 15 is a cross sectional (interior) view of a back of a square shaped vertical stack of pet furniture units, representing an embodiment of the invention.

FIG. 16 is a cross sectional (interior) view of a second (left) side of a square shaped vertical stack of pet furniture units, representing an embodiment of the invention.

FIG. 17 is a perspective view of a one piece litter box having a vacuum air filtration system, representing an embodiment of the invention.

FIG. 18 is a perspective view of a one piece stack of units including a litter box unit having a vacuum air filtration system, representing an embodiment of the invention.

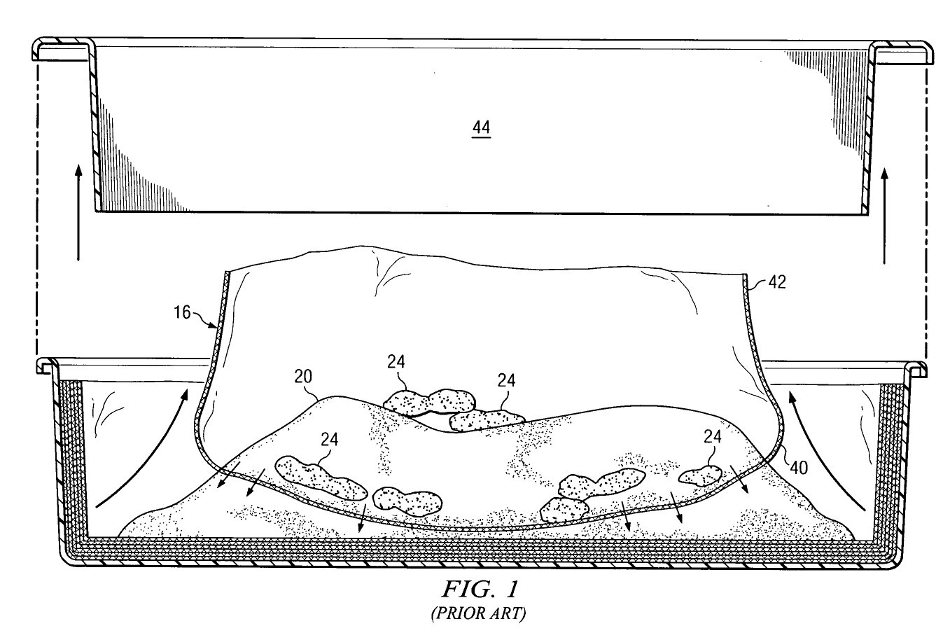

### DESCRIPTION OF PREFERRED EMBODIMENTS

Embodiments of the invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the embodiments of the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Within this application several publications are referenced for the purpose of indicating the background of embodiments of the invention and illustrating the state of the art. Full citations for these publications may be found at the end of the specification immediately preceding the claims after the section heading References. The disclosures of all these publications in their entireties are hereby expressly incorporated by reference herein for the purpose of indicating the background of embodiments of the invention and illustrating the state of the art.

The below-referenced U.S. patents disclose embodiments that are useful for the purposes for which they are intended. The entire contents of U.S. Pat. Nos. 4,279,217; 4,312,295; 4,615,300; 4,646,684; 4,784,082; 4,870,924; 4,934,316; 4,976,218; 5,006,379; 5,031,578; 5,121,712; 5,207,772; 5,471,950; 5,488,929; 5,488,930; 5,551,376; 5,564,366; 5,752,466; 5,850,798; 5,878,693; 5,964,186; 5,983,832; and 6,039,003 are hereby expressly incorporated by reference herein for all purposes. The entire contents of U.S. Pat. Nos. 5,351,646; 5,575,238; 5,651,332; D397,832; D406,678; 5,913,750; 6,286,458 and D461,026 are hereby expressly incorporated by reference herein for all purposes.

An embodiment of the invention can include a litter box liner with one or more tall sides. The tall sides are intended to keep the litter and animal waste inside the liner and away from the inner walls of the litter box. Each of the sides of the liner, as well as the bottom of the liner, can be termed webs. There can be a single side (e.g., in the case of a circular litter box). Preferred embodiments of the invention include an entry web that defines an aperture through which an animal (e.g., cat) can enter the litter box. The aperture can be circular, square, rectangular or any other shape that permits an animal to transit the entry web. Although a preferred embodiment of the invention defines a 8.5 inch square aperture, the aperture can be of any size.

An embodiment of the invention can include a shaped sifting litter box liner. Preferred embodiments of the invention include a sifting web that defines a plurality of openings (e.g., a mesh, a sieve or similar structure) that sifts lifter when the liner is picked up. The shaped sifting litter box liners are intended for use with clumping cat litter.

Although the portion of the liner that includes the plurality of openings can be any size, preferred embodiments of the invention include a perforated section that can be approximately 8 inches by approximately 10 inches.

Preferred embodiments of the invention are fitted by the use of seams between at least two webs. The seams permit a configuration of the webs that obviates the excess material involved when a generic shaped bag is adapted to a specific litter box.

The shaped sifting liners can be attached to a litter box to keep the litter box protected. The structure to attach the liners to the sides of the box can include pegs or flaps. A peg held shaped sifting liner can be held by two pegs on each of four sides of the box. Preferred embodiments of the invention have seamed flap(s) at the top of the web(s) designed to fold over the top of the sides of the litter box. Although preferred embodiments of the invention have 2 inch flaps all the way around, the flaps can be any width and be coextensive with all, most or some of the sides of the litter box. Of course, the invention can utilize other structures to keep the liner in place. By keeping the liner in place, litter boxes are substantially protected including the whole height of their interior side walls, thereby significantly reducing, if not eliminating the need to ever wash the litter box (e.g., cat box).

The shaped sifting liners can be packaged as rolls or nests. The sides can be folded onto the bottom and then a co-joined series of liners can be rolled. There could be 2 rolls per package. Alternatively, each package can include 30 sifting sheets and 1 or 2 solid non-sifting sheet on the bottom of a nested stack, the later intended to lift out remaining litter and then be replaced with a new liner pack and fresh litter.

The liners should be thin in order to permit stacking 30 liners (sheets), including the flap(s). The liners should be strong so as not to break under the weight of the litter while they are sifted.

An embodiment of the invention can include an open bottom litter box cover that fits over and surrounds both the litter box and the shaped sifting litter box liner. The litter box cover is placed over the subassembly of the litter box and the shaped sifting litter box liner after the shaped litter box liner is placed in the litter box. The cover does not necessarily hold the liners in place, it can be merely for aesthetics.

The cover and litter box can be made of plastic. Since substantially all parts of the box are protected, the cover and/or box can be made of any suitable material, such as plastic, fiberglass, cardboard (as in a portable/disposable version) or wood. The litter box and/or cover can be made any size. The litter box can be located inside furniture, with or without a cover. The cover can optionally include a cushion (bed) on top.

An embodiment of the invention can also be included in a kit. The kit can include some, or all, of the components that an embodiment of the invention includes. The kit can be an in-the-field retrofit kit to improve existing systems that are capable of incorporating an embodiment of the invention. The kit can include instructions for practicing an embodiment of the invention. Unless otherwise specified, the components and/or instructions of the kit can be the same as those used in an embodiment of the invention.

The particular manufacturing process used for making the shaped sifting litter box liner should be inexpensive and reproducible. Conveniently, the manufacture of an embodiment of the invention can be carried out by using any molding method. For the manufacturing operation, it is an advantage to employ a blow molding or injection molding technique.

However, the particular manufacturing process used for manufacturing the shaped sifting litter box liner is not essential to an embodiment of the invention as long as the shaped sifting litter box liners provide the described functionality and can be nested or stacked within one another. Normally those who make or use an embodiment of the invention will select the manufacturing process based upon tooling and energy requirements, the expected application requirements of the final product, and the demands of the overall manufacturing process.

The particular material used for fabricating the shaped sifting litter box liner should be impermeable to liquids and strong enough to permit vigorous sifting without tearing, ripping or bursting. Conveniently, the shaped sifting litter box liner can be made of any polymeric material. It is preferred that the material be relatively inexpensive. For the manufacturing operation, it is an advantage to employ a thin high density polyethylene material.

However, the particular material selected for the shaped sifting litter box liners is not essential to an embodiment of the invention, as long as it provides the described function. Normally, those who make or use an embodiment of the invention will select the best commercially available material based upon the economics of cost and availability, the expected application requirements of the final product, and the demands of the overall manufacturing process.

### EXAMPLES

Specific embodiments of the invention will now be further described by the following, nonlimiting examples which will serve to illustrate in some detail various features. The following examples are included to facilitate an understanding of ways in which an embodiment of the invention may be practiced. It should be appreciated that the examples which follow represent embodiments discovered to function well in the practice of an embodiment of the invention, and thus can be considered to constitute preferred mode(s) for the practice of the embodiments of the invention. However, it should be appreciated that many changes can be made in the exemplary embodiments which are disclosed while still obtaining like or similar result without departing from the spirit and scope of an embodiment of the invention. Accordingly, the examples should not be construed as limiting the scope of an embodiment of the invention.

### Example 1

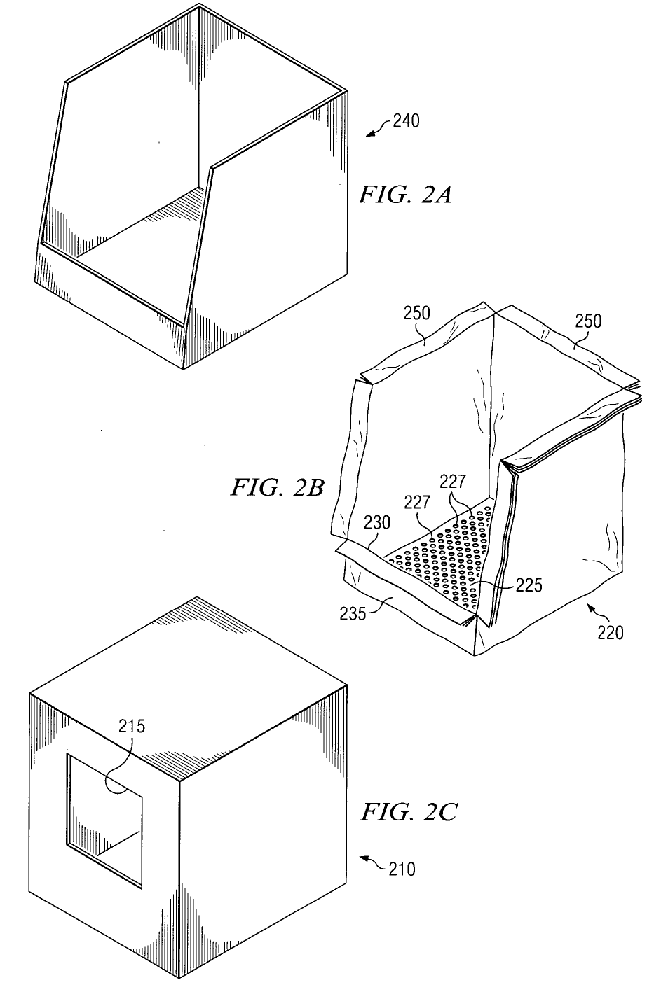

Referring to FIGS. 2A-2C, an exploded assembly includes a rectilinear cover 210, a plurality of shaped sifting liners 220 each with an entry structure 230, and a litter box 240. The liners 220 are located within the box 240 and then the cover 210 can be placed in position. The cover 210 defines an opening 215 through which a cat can pass.

The plurality of shaped sifting litter box liners 220 are concentrically nested together. Each of the plurality of shaped sifting litter box liners 220 includes a sifting web 225 having a section that defines a plurality of perforations 227 adapted to sift clumping litter. Each of the plurality of shaped sifting litter box liners 220 includes an entry web 235 coupled to the sifting web 225, the entry web 235 defining the entry structure 230 that is adapted to permit passage of an animal through the entry web 235. The shaped sifting liners 220 of this example are held in place within the litter box by a plurality of seamed flaps 250. The litter box 240 defines an entry structure.

### Example 2

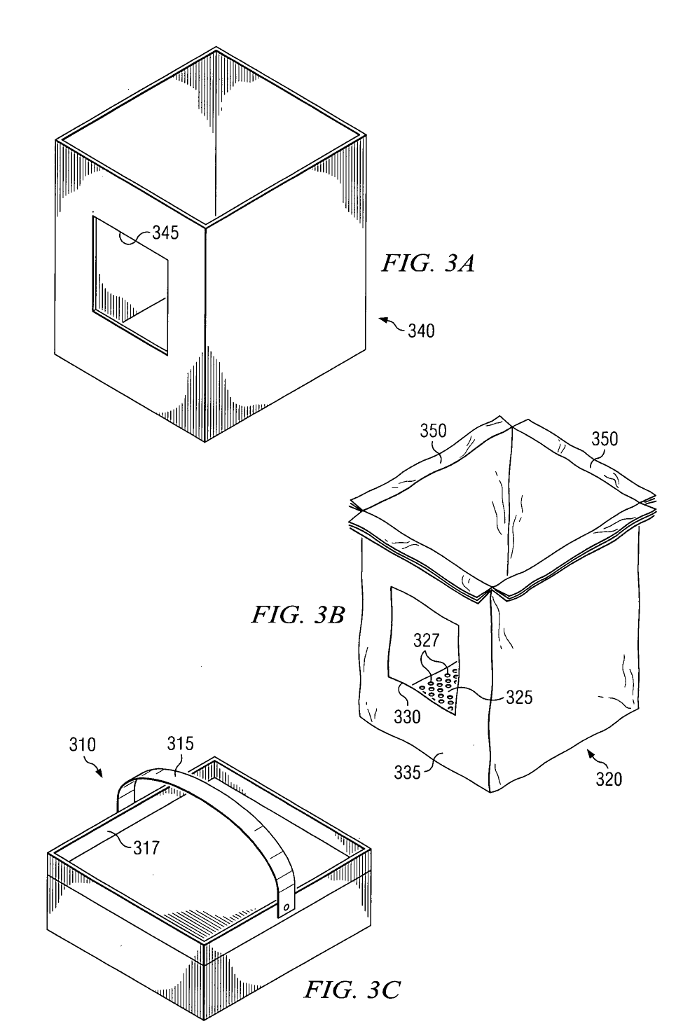

Referring to FIGS. 3A-3C, an exploded assembly includes a rectilinear cover 310, a plurality of shaped sifting liners 320 each with an entry structure 330, and a litter box 340. The liners 320 are located within the box 340 and then the cover 310 can be placed in position. The cover 310 includes a handle 315. The cover 310 includes a retaining wall 317 that can be used to hold a pillow (e.g., cat bed) not shown in place on top of the cover 310.

The plurality of shaped sifting litter box liners 320 are concentrically arranged with regard to another so as to define a nest. Each of the plurality of shaped sifting litter box liners 320 includes a sifting web 325 having a section that defines a plurality of perforations 327 adapted to sift clumping litter. Each of the plurality of shaped sifting litter box liners 320 includes an entry web 335 coupled to the sifting web 325, the entry web 335 defining the entry structure 330 that is adapted to permit passage of an animal through the entry web 335. The shaped sifting liners 320 of this example is held in place within the litter box by a plurality of flaps 350. The litter box 340 defines an entry structure that includes an aperture 345.

### Example 3

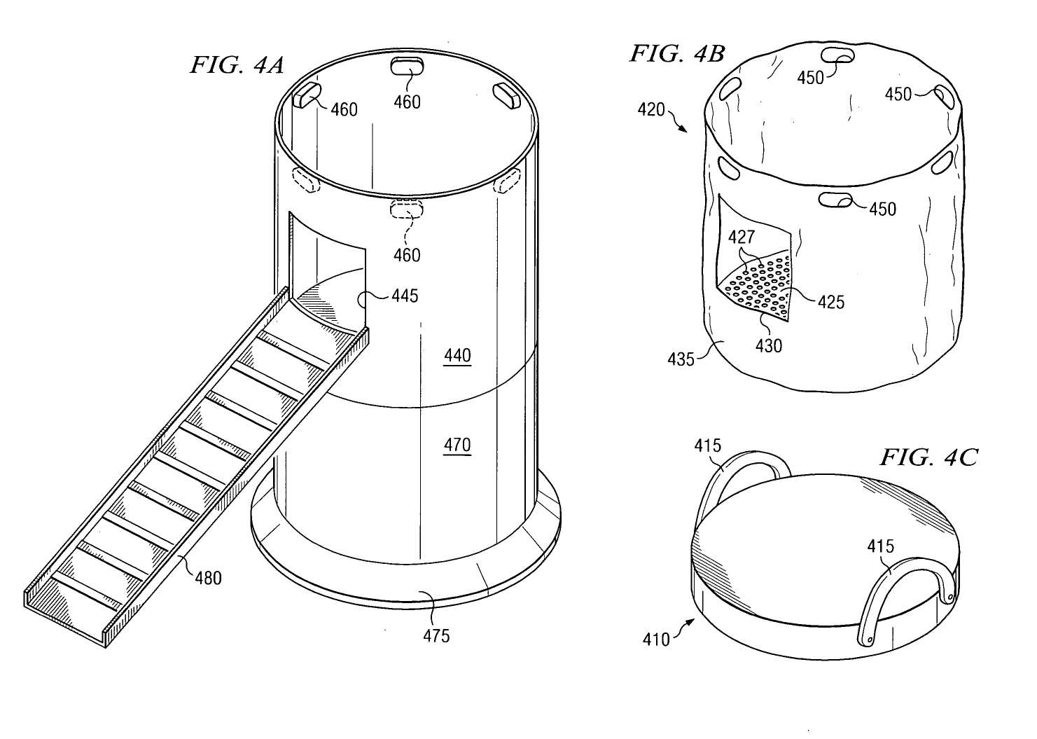

Referring to FIGS. 4A-4C, an exploded assembly includes a circular cover 410, a shaped sifting liner 420 with an entry structure 430, and a litter box 440. The liner 420 is located within the box 440 and then the cover 410 can be placed in position. The cover 410 includes a pair of handles 415.

The shaped sifting litter box liner 420 includes a sifting web 425 having a section that defines a plurality of perforations 427 adapted to sift clumping litter. The shaped sifting litter box liner 420 includes an entry web 435 coupled to the sifting web 425, the entry web 435 defining the entry structure 430 that is adapted to permit passage of an animal through the entry web 435. The shaped sifting liner of this example is held in place within the litter box by six openings 450 (apertures) each of which is adapted and located to co-act with a peg 460 or other suspending structures provided on litter box 440. The litter box 440 defines an entry structure that includes an aperture 445. The litter box 440 can be coupled to a base 470 that includes a weighted bottom 475. The litter box 440 can be coupled to a climbing structure 480 such as a ramp and/or ladder.

### Alternative Embodiments

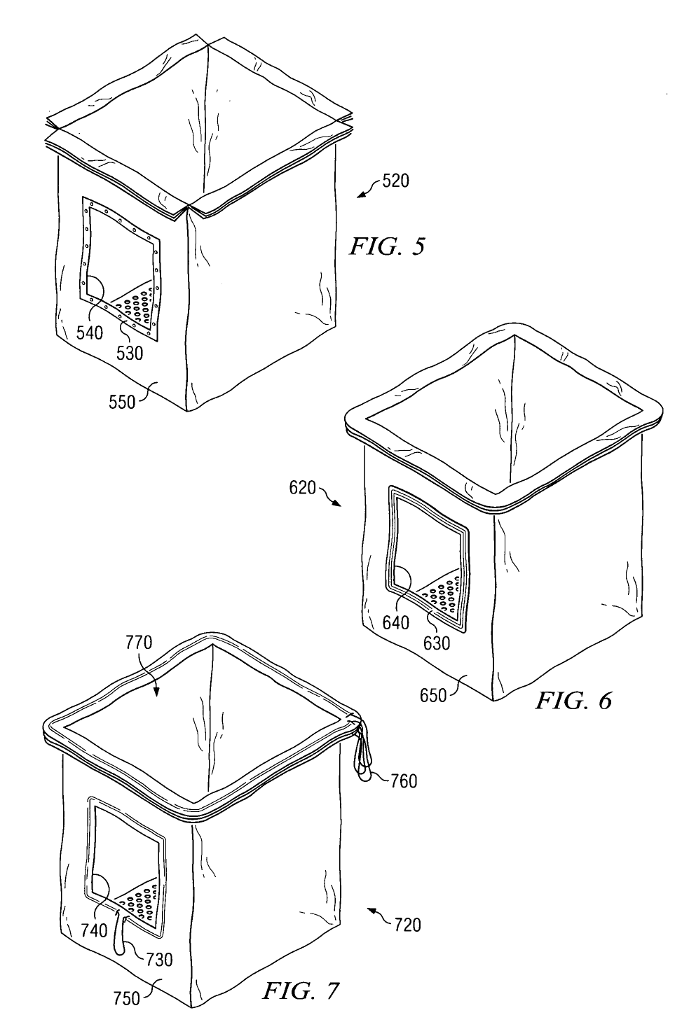

Referring to FIG. 5, a plurality of shaped sifting litter box liners 520 is characterized by each of the liners including a snap-fit fixture 530 located around the perimeter of an aperture 540 located in a entry web 550. The plurality of shaped sifting litter box liners are concentrically arranged with regard to another to define a nest. The particular snap-fit fixture 530 of this embodiment is convex in cross-section taken perpendicular to the direction around the perimeter.

Referring to FIG. 6, a plurality of shaped sifting litter box liners 620 is characterized by each of the liners including a zip-lock fixture 630 located around the perimeter of an aperture 640 located in a entry web 650. The plurality of shaped sifting litter box liners are concentrically arranged to define a nest. The particular zip-lock fixture 630 of this embodiment is concave in cross-section taken perpendicular to the direction around the perimeter.

Referring to FIG. 7, a plurality of shaped sifting litter box liners 720 is characterized by each of the liners including a drawstring 730 located around the perimeter of an aperture 740 located in a entry web 750 and another drawstring 760 located around a top opening 770. Again, the plurality of shaped sifting litter box liners 720 are concentrically arranged to define a nest. The liners of this particular embodiment are plastic and each of the shaped sifting litter box liners 720 is flexible enough to form a closed bag when the top opening drawstring is displaced.

### Litter Box Vacuum Air Filtration System

A deterrent to using the existing sifting litter is the dust it creates during the sifting process. Even the 99% dust free litter creates a tremendous amount of dust when lifting the liner. The dust fog can fill a small room (such as a utility room), which is why sifting liners have not gained much popularity to date.

What is needed is a vacuum air filtering system that attaches to the litter box to draw in the dust the sifting litter creates when lifted. This vacuum air filtration system can direct the air through three filters. The first filter will be a dust (particulate) filter. The second filter can be an activated charcoal filter for odor control. The third filter can have a pleasant scent distribution structure such as a wick or atomizer that will disperse this pleasant scent into the room. Thus, the invention can significantly reduce dust, control odor and improve cleanliness.

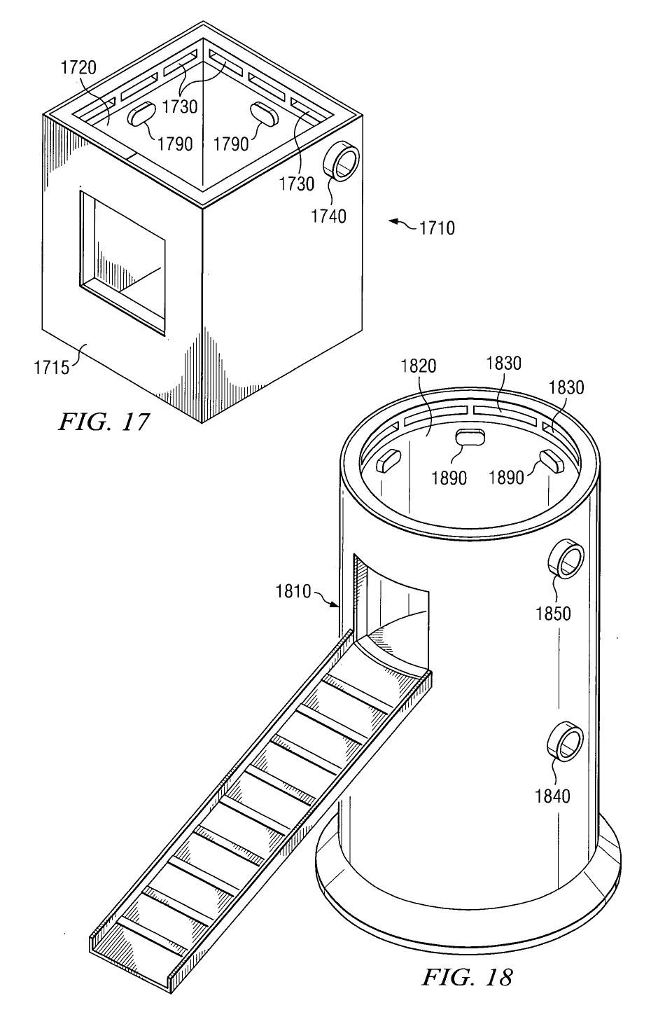

Referring to FIG. 17, a one piece litter box 1710 includes an outer shell 1715 and an inner shell 1720. The inner shell 1720 defines a plurality of apertures 1730 that can function as vacuum inlets. The box 1710 includes a vacuum outlet 1740. A fan and filter assembly (not shown in FIG. 17) can be located between the apertures 1730 and the outlet 1740. The filter assembly can include a first particulate filter, a second chemical filter and a third scent filter. The outlet 1740 can be provided with a nozzle to define a play area where filtered air evacuated from within the inner shell 1720 is directed downward and to the side toward feathered and other light weight toys dangling on various length elastic strings. A plurality of pegs 1790 are coupled to the inner shell 1720. The pegs 1790 can function to hold a sifting litter box liner in place during normal use.

Referring to FIG. 18, a one piece stack of units 1810 including a litter box unit includes a vacuum air filtration system. The one piece stack of units 1810 includes an outer shell 1815 and an inner shell 1820. The inner shell 1820 defines a plurality of apertures 1830 that can function as vacuum inlets. The stack of units 1810 includes a vacuum outlet 1840. A fan and filter assembly (not shown in FIG. 18) can be located between the apertures 1830 and the outlet 1840. The filter assembly can include a first particulate (dust) filter, a second chemical filter (e.g., activated carbon) and a third scent filter (e.g., evaporative wick). The outlet 1840 can be provided with a nozzle (e.g., spreader) to define a play area where filtered air evacuated from within the inner shell 1820 is directed downward and to the side toward feathered and other light weight toys dangling from a hook and loop (e.g., Velcro) strip on various length elastic strings. The stack of units 1810 includes a bypass vacuum outlet 1850. The bypass vacuum outlet 1850 can be located between the apertures 1830 and the fan and filter assembly. Preferred bypass outlet embodiments include a check (i.e., one-way) valve to prevent ambient air from entering the unit via bypass outlet 1850. If the outlet 1840 is also provided with a check valve to prevent ambient air from entering the unit, then an external vacuum cleaner (e.g., a powerful wet/dry shop vacuum) can be coupled to the bypass outlet 1850 to collect dust generated during sifting of the litter. The use of an external vacuum cleaner in conjunction with the bypass outlet 1850 has the advantages of collecting the dust externally from the litter box unit for easy disposal and simultaneously reducing clogging of the filter assembly, thereby reducing the time needed for maintenance of the unit. A plurality of pegs 1890 are coupled to the inner shell 1820. The pegs 1890 can function to hold a sifting litter box liner in place during normal use.

In the case of the one piece units, the filtered exhaust air shaft can be cloistered in the side storage areas, preferably extending about halfway down the side to the top of a play area. In this way, the cloistered conduits will not be directly visible, thereby improving esthetics. Stack embodiments of the invention should include a wall attachment for stability. Preferred stack embodiments of the invention include two or more wall attachments (e.g., a first attachment toward the top and a second attachment toward the bottom), as cats are unlikely to get on a structure that is wobbly.

### Vertically Integrated Embodiments

A problem faced by pet owners, especially in smaller apartments, is that there may be a lack of space for pets to eat, sleep, toilet and play. Each of these activities requires space and typically some accoutrements and/or supplies. What is needed is an approach to minimizing floor space devoted to pet accoutrements and/or supplies. Another problem faced by pet owners is that after arranging their pet accoutrements and/or supplies, the desire to achieve a better (e.g., more efficient and/or less cluttered) arrangement may create a need to rearrange the accoutrements and/or supplies. Also, moving to a new home (e.g., a different apartment) requires packing, moving, unpacking and rearranging the accoutrements and/or supplies, perhaps in a completely different spatial arrangement. What is needed, therefore, is a solution that permits a reconfigurable, vertical assembly of pet furniture units.

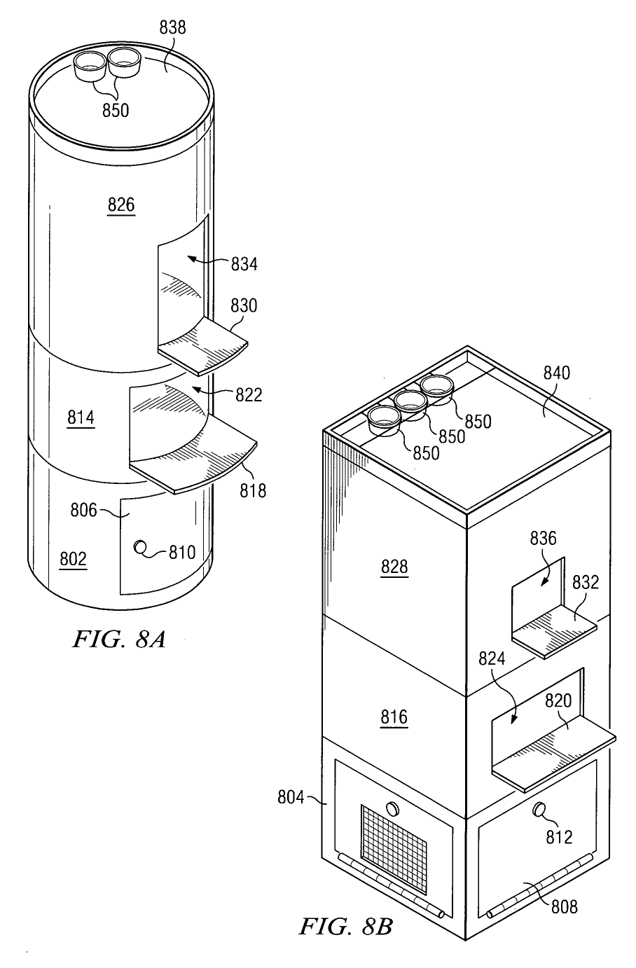

Referring to FIGS. 8A and 8B, the invention can include pet furniture comprised of a vertical series of sections. As depicted in FIGS. 8A and 8B, a storage box unit 802, 804 can be located at the bottom of a vertical stack of modules. The storage box unit 802, 804 can include a hinged door 806, 808 with a cabinet knob 810, 812. The storage box unit 802, 804 can include a pull-out drawer base (not shown in FIGS. 8A and 8B) behind the door, preferably on bearing equipped runners. A sleeping box unit 814, 816 can be located on top of the storage box unit 802, 804. The sleeping box unit 814, 816 can include a platform 818, 820 beneath a passage way 822, 824. A litter box unit 826, 828 can be located on top of the sleeping unit 814, 816. The litter box unit 826, 828 can include a platform 830, 832 beneath a passage way 834, 836. An eating unit 838, 840 can be located on top of the litter box unit 826, 828. The eating unit 838, 840 can be provided with removable dishes 850 located in a (e.g., wire) rack (not shown in FIGS. 8A and 8B). Of course, the invention is not limited to a vertical series of units. For instance, the invention can include a horizontal (or other direction) series of units. Further, the invention can include a set of units characterized by both a vertical series of units and a horizontal series of units, as well as other directional series, such as a diagonal series of units.

An inclined ramp (not shown in FIGS. 8A and 8B) can be provided leading to the platform 818, 820 beneath the sleeping unit passage 822, 824. Similarly, an inclined ramp (not shown in FIGS. 8A and 8B) can be provided leading from the sleeping unit platform 818, 820 to the platform 830, 832 beneath the litter box unit passage way 834, 836. Likewise, an inclined ramp (not shown in FIGS. 8A and 8B) can be provided leading from the litter box unit platform 830, 832 to the eating unit 838, 840. Preferrably, the (exterior of the) unit(s) can be wood. Alternatively, the (interior and/or exterior of the) unit(s) can be plastic. Alternatively, the exterior of the units can be covered with carpet or hemp, with the pet thereby encouraged to climb-up the outside of the stack.

With regard to vertically integrated embodiments of the invention, it is important to appreciate that with the exception of an open top upper unit (if present), such as the eating unit 838, 840, the other units of the stack can be arranged in all possible orders from the bottom upwards. For instance, with regard to the particular embodiments depicted in FIGS. 8A and 8B, the alternatives to locating the storage box unit 802, 804 at the bottom of the stack are to locate the sleeping unit 814, 816 at the bottom of the stack or the litter box unit 826, 828 at the bottom of the stack. Of course, the invention is not limited to such variable order embodiments.

It is also important to appreciate that with regard to vertically integrated embodiments of the invention, the units can be configured with multi-fold symmetry with regard to an axis defined by the combination of the units so that they can arranged with their individual units rotated to face in different directions. Thus, with regard to the circular embodiment depicted in FIG. 8A each of the units 802, 814, 826 could be orientated to face in one of all directions. In the case of an oval embodiment, each of the units could be orientated in one of two directions. With regard to the square embodiment of FIG. 8B, each of the units 804, 816, 828 could be orientated to face in one of four directions. In the case of a rectangular embodiment, each of the units could be orientated in one of two directions. Of course, the invention is not limited to multi-fold symmetrically variable orientation embodiments.

Optionally, the units can be provided with conduits. The conduits can be for ventilation, electrical power, fluids and/or even solids. Thus, a vertical ventilation shaft can be located between an outer web (e.g., carpeted exterior housing) and an inner web (e.g., padded interior housing) of a unit and configured so that the apertures defining the ends of such a conduit are located directly above one another (e.g., coaxially located). It can be appreciated that in this way, ventilation, electrical, fluid and/or even solid transport functionalities of a vertical series of units can be interconnected, without regard to the serial order in which the series of units are vertically arranged. Moreover, one or more of the functionalities of a given unit can be extended to one or more adjacent units without regard to the multi-fold rotational symmetry (basal plane) orientation of the one or more adjacent units provided corresponding conduit(s) of those one or more of the adjacent unit(s) are in alignment with the conduit(s) of the given unit.

For instance, an exhaust (i.e., overpressure) function of the litter box unit can be extended to a gas conduit of an adjacent unit that is orientated in one of a plurality of directions if the gas conduit of the litter box unit is continuous around substantially all of the perimeter of the lifter box unit (e.g., a vent shaft of a square litter box unit goes around all four sides of the square litter box unit). With regard to the embodiments depicted in FIGS. 8A and 8B, this would permit an exhaust from the litter box unit 826, 828 to be routed down to and through the sleeping unit 814, 816 (e.g., to an exhaust vent in storage box unit 802, 804) no matter which way the passage ways of the litter box unit and sleeping unit were facing with regard to their multi-fold rotational symmetry (basal plane) orientation.

### Example 4

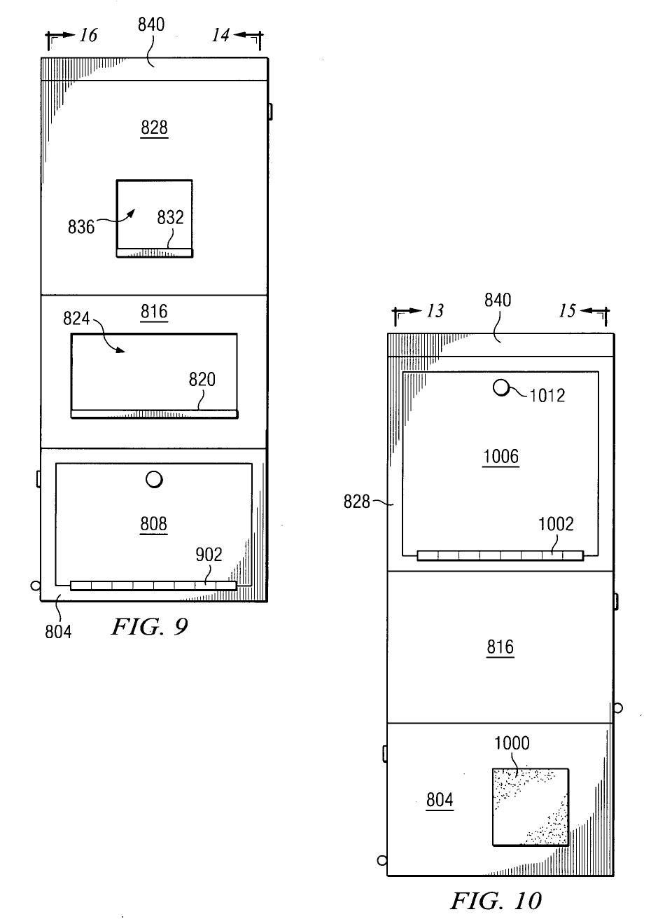

Referring to FIGS. 9-16, four orthographic exterior views and four orthographic cross section (interior) views are depicted of the square shaped vertical stack of pet furniture shown in FIG. 8B. Although this preferred embodiment of the invention is intended, sized, configured and constructed for domesticated cats, the invention is not limited to cat furniture.

Referring to FIG. 9, the outside of the front of the stack is depicted. The storage box unit 804 includes a hinged door 806 having a hinge 902 and the cabinet knob 812. A sleeping box unit is coupled to the top of the storage box unit 804. The sleeping box unit 816 includes the platform 820 beneath the passage way 824. A litter box unit 828 is coupled to the top of the sleeping unit 816. The litter box unit 828 includes the platform 832 beneath the passage way 836. The eating unit 840 is coupled to the top of the litter box unit 828.

Referring to FIG. 10, the outside of a first side (the right side) of the stack is depicted. The storage box unit 804 includes a mounting area 1000. The mounting area 1000 can include a reversibly manually actuatable fastener structure, for example a hook and loop material such as Velcro. A section of carpet or hemp can be coupled to the reversibly manually actuatable fastener. The litter box unit 828 includes a hinged door 1006 having a hinge 1002 and a cabinet knob 1012.

Referring to FIG. 11, the outside of the back of the stack is depicted. The sleeping box unit 816 includes a hinged door 1106 having a hinge 1102 and a cabinet knob 1112. The hinged door 1106 can be useful for improving access to the sleeping area for cleaning. In the interest of saving space, it is preferred to locate the hinges of the exterior doors at the bottom of the doors for an approximate 10 inch pull-out.

Alternatively, the hinges can be located at either side, or even at the top, of the doors and the doors designed to swing fully. A liquid conduit connector 1120 is coupled to the storage box unit 804. An electrical conduit connector 1130 is coupled to the storage box unit 804.

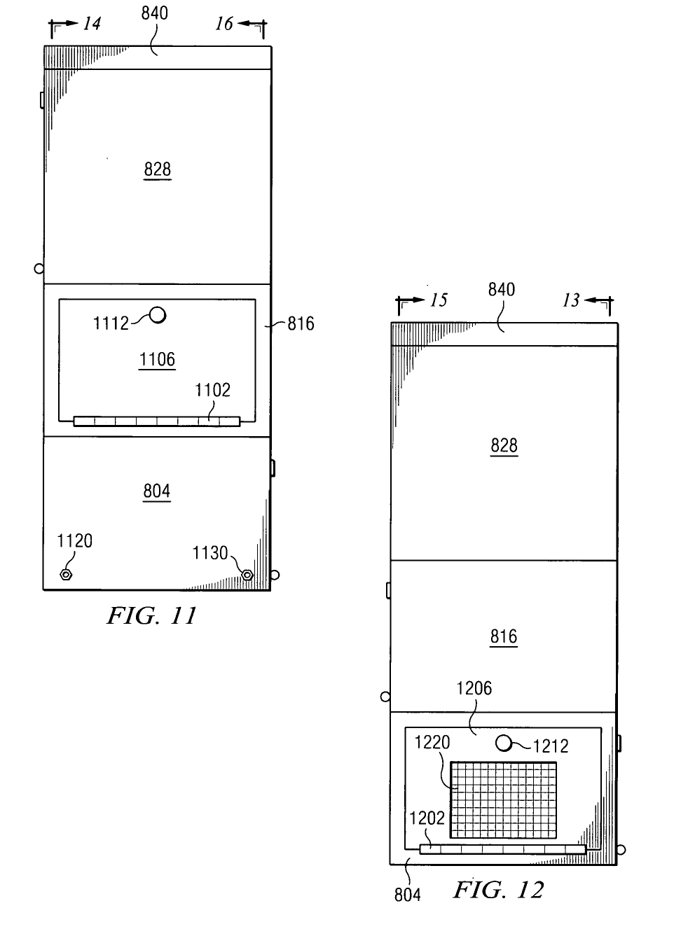

Referring to FIG. 12, the outside of a second side (the left side) of the stack is depicted. The storage box unit 804 includes another hinged door 1206 having a hinge 1202 and a cabinet knob 1212. The hinged door 1206 includes an open mesh 1220, the wires of which are spaced such that a cat can reach through a plane defined by the door 1206. It should be noted that one or more the corners of the lower storage box unit can be provided with a corner brush groomer.

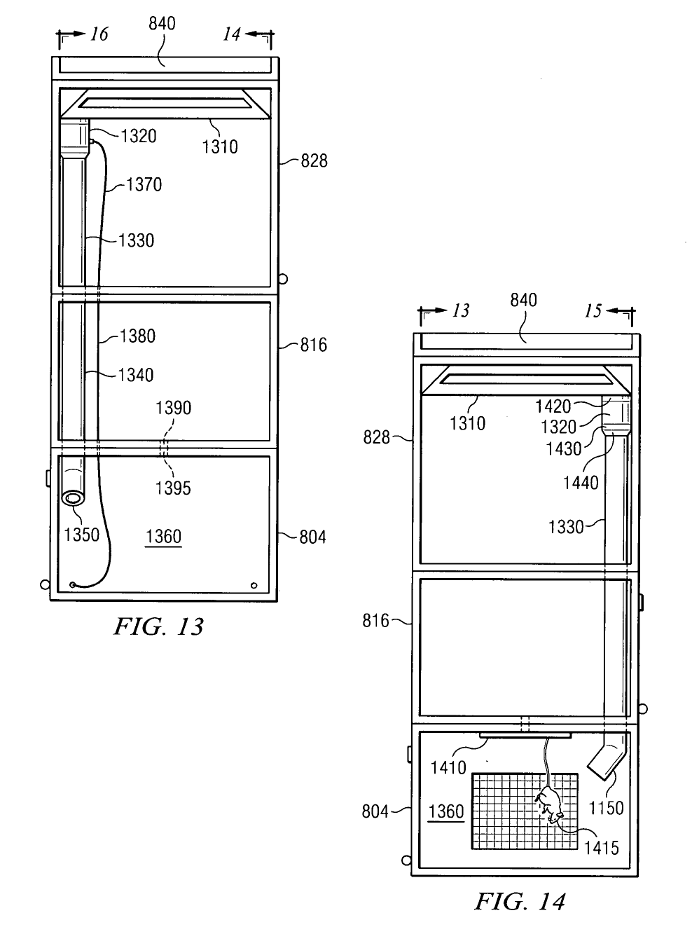

Referring to FIG. 13, the inside (looking toward the back) of the stack is depicted. An air intake 1310 is coupled to a fan 1320. More generically, the air intake 1310 is an example of a vacuum inlet. The fan is coupled to a litter box air shaft 1330. Another air shaft 1340 is aligned with and coupled to the litter box air shaft 1330 to define a ventilation conduit. A nozzle 1350 is coupled to the ventilation conduit. The nozzle 1350 is located in and coupled to an expansion chamber 1360. A litter box electrical conductor 1370 is aligned with and coupled to another box electrical conductor 1380 to define an electrical conduit. It should be noted that the motor can be equipped to turn on automatically (e.g., by opening an inductively coupled circuit or extending a mechanical switch) when the litter box unit is opened for cleaning. The bottom of sleeping box unit 816 can be provided with an aperture 1390 through which an electric cable can be routed to provide power for a heated bed (not shown in FIG. 13). By locating the aperture 1390 approximately at the middle of the bottom of sleeping box unit 816, the cable can be made less accessible to a curious pet. The aperture 1390 can be provided with a partial plug (not shown in FIG. 13) to reduce the size of the opening after the electric cable plug is threaded through the aperture 1390. Optionally, the upper web of storage unit 804 can be provided with an aperture 1395 through which the electric cable can be routed. In either case, the electric cable can be routed out the back, side or even from of the stack (to a separate power source not shown in FIG. 13) or conductively coupled to the electrical conductor 1370.

Referring to FIG. 14, the inside (looking toward the left) of the stack is depicted. A reversibly manually actuatable fastener 1410 is located in the expansion chamber 1360. A moving part 1415 (e.g., a rubber toy mouse) is coupled to the reversibly manually actuatable fastener 1410 with an elastic connector. An exhaust vent is coupled to the expansion chamber 1360. The exhaust vent includes the open mesh 1220. It should be noted that the motor can also be turned on manually (e.g., with a rotary timer switch) for freshening the box and/or for imparting motion to the moving part 1415 via the ventilation conduit, nozzle and expansion chamber (e.g., for cat playtime). A particle filter 1420 is located between the air intake 1310 and the fan 1320. An activated charcoal filter 1430 located between the air intake 1310 and the litter box air shaft 1330. A scent dispenser 1440 is located between the air intake 1310 and the litter box air shaft 1330.

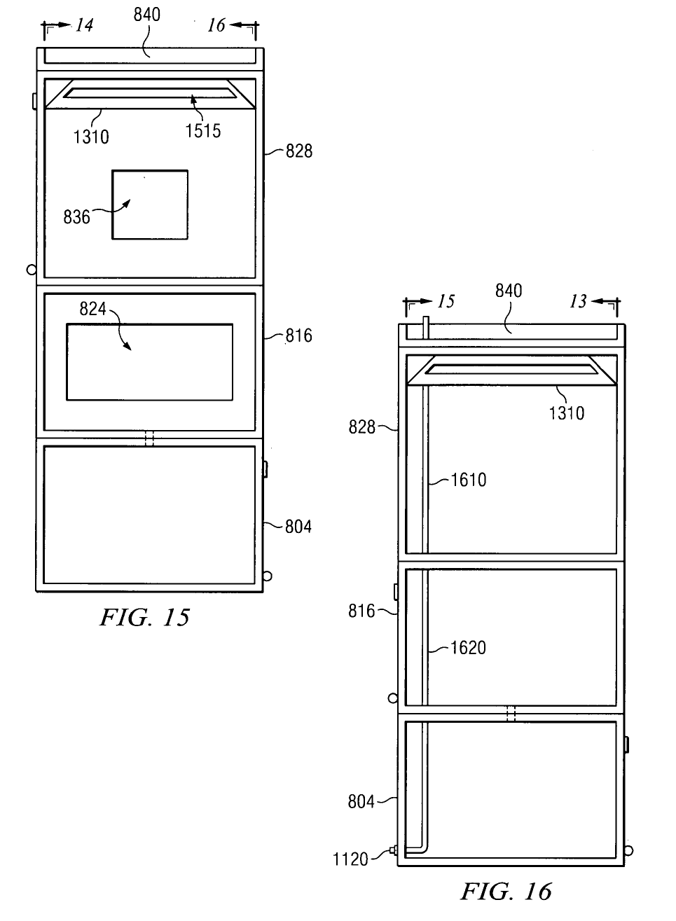

Referring to FIG. 15, the inside (looking toward the front) of the stack is depicted. The air intake 1310 defines a slot 1515 that is located along substantially all of an upper, interior edge of the lifter box liner. The invention can include the division of the interior of the litter box unit to create a storage area for extra sifting liners by the insertion of a horizontal web (e.g., 2-3 inches) above the interior of the bottom of the lifter box unit.

Referring to FIG. 16, the inside (looking toward the right) of the stack is depicted. A lifter box liquid conductor 1610 is aligned with and coupled to another box liquid conductor 1620 to define a liquid conduit. The liquid conduit can provide a continuous source of water for replenishment of a drinking bowl. Similarly, the stack can be provided with a solid transport conduit for food. The liquid conduit (and/or the ventilation conduit and/or the electrical conduit can be provided with metal cable sheathing and/or walled off from areas occupied by the pet with a partition. If one or more partitions are utilized, it is advantageous to provide corresponding exterior door(s) to avoid wasting space that can be used for storage.

### Advantages

Embodiments of the invention, can be cost effective and advantageous for at least the following reasons. Embodiments of the invention protect the inside of litter boxes, thereby eliminating (or at least substantially reducing) the need to clean the lifter box.

Embodiments of the invention improve quality and/or reduce house keeping burdens compared to previous approaches. An advantage of embodiments of the invention can include reducing the time needed for the unpleasant chore of cleaning a cat lifter box.

An advantage of embodiments of the invention can include avoiding the cost of replacing a conventional lifter box when urine has soiled and corroded the conventional box beyond cleaning. An advantage of embodiments of the invention can include space saving by having a high-rise of units instead of having different areas spread out all over the house or apartment. An advantage of embodiments of the invention can include the convenience of having everything a cat needs in one place.

### DEFINITIONS

The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically. The term proximate, as used herein, is intended to mean close, near adjacent and/or coincident; and includes spatial situations where specified functions and/or results (if any) can be carried out and/or achieved. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present).

The terms a or an are employed for grammatical style and merely for convenience.

The term plurality is intended to mean two or more than two. The term any is intended to mean all applicable members of a set or at least a subset of all applicable members of the set. The phrase any integer derivable therein is intended to mean an integer between the corresponding numbers recited in the specification. The phrase any range derivable therein is intended to mean any range within such corresponding numbers.

The term means, when followed by the term “for” is intended to mean hardware, firmware and/or software for achieving a result. The term step, when followed by the term “for” is intended to mean a (sub)method, (sub)process and/or (sub)routine for achieving the recited result.

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. The terms “consisting” (consists, consisted) and/or “composing” (composes, composed) are intended to mean closed language that does not leave the recited method, apparatus or composition to the inclusion of procedures, structure(s) and/or ingredient(s) other than those recited except for ancillaries, adjuncts and/or impurities ordinarily associated therewith. The recital of the term “essentially” along with the term “consisting” (consists, consisted) and/or “composing” (composes, composed), is intended to mean modified close language that leaves the recited method, apparatus and/or composition open only for the inclusion of unspecified procedure(s), structure(s) and/or ingredient(s) which do not materially affect the basic novel characteristics of the recited method, apparatus and/or composition.

Unless otherwise defined, all technical and scientific terms used herein have the same meaning as commonly understood by one of ordinary skill in the art to which this invention belongs. In case of conflict, the present specification, including definitions, will control.

### CONCLUSION

The described embodiments and examples are illustrative only and not intended to be limiting.

Although embodiments of the invention can be implemented as a separate module, embodiments of the invention may be integrated into the system(s) with which they are associated. All the disclosed embodiments of the invention disclosed herein can be made and used without undue experimentation in light of the disclosure. Although the best mode of the invention contemplated by the inventor(s) is disclosed, embodiments of the invention are not limited thereto. Embodiments of the invention are not limited by theoretical statements (if any) recited herein. The individual steps of embodiments of the invention need not be performed in the disclosed manner, or combined in the disclosed sequences, but may be performed in any and all manner and/or combined in any and all sequences. The individual components of embodiments of the invention need not be formed in the disclosed shapes, or combined in the disclosed configurations, but could be provided in any and all shapes, and/or combined in any and all configurations. The individual components need not be fabricated from the disclosed materials, but could be fabricated from any and all suitable materials.

It can be appreciated by those of ordinary skill in the art to which embodiments of the invention pertain that various substitutions, modifications, additions and/or rearrangements of the features of embodiments of the invention may be made without deviating from the spirit and/or scope of the underlying inventive concept. All the disclosed elements and features of each disclosed embodiment can be combined with, or substituted for, the disclosed elements and features of every other disclosed embodiment except where such elements or features are mutually exclusive. The spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

### REFERENCES

Marks Mechanical Engineering Handbook, 10th ed., McGraw Hill, (Eugene A. Avallone et al. eds.), 1996.
Concise Encyclopedia of Polymer Science and Engineering, John Wiley & Sons, (Jacqueline I. Kroschwitz et al. eds.), 1990.

What is claimed is:

1. A method, comprising:
evacuating gas from a litter box unit through a ventilation conduit defined by a litter box air shaft; and
imparting motion to a moving part by impinging the moving part with evacuated gas.

2. The method of claim 1, further comprising filtering the evacuated gas.

3. The method of claim 1, further comprising dispensing a scent into the evacuated gas.
